(19) United States
(12) Patent Application Publication
(10) Pub. No.: US 2012/0084110 A1
(43) Pub. Date: Apr. 5, 2012

(54) SYSTEM AND METHOD FOR SMART OIL, GAS AND CHEMICAL PROCESS SCHEDULING

(75) Inventors: Lei Wu, Houston, TX (US); Dong Dong, Sugar Land, TX (US); David Jasper, Houston, TX (US); Shaolong Dai, Houston, TX (US)

(73) Assignee: M3 TECHNOLOGY, INC., Houston, TX (US)

(21) Appl. No.: 13/252,000

(22) Filed: Oct. 3, 2011

Related U.S. Application Data
(60) Provisional application No. 61/390,106, filed on Oct. 5, 2010.

(51) Int. Cl. G06Q 10/06

(52) U.S. Cl. 705/7.13

(57) ABSTRACT

A system and method support smart scheduling for an oil, gas and chemical process system with a plurality of facility units. A subset of the process facility units can be selected from the plurality of process facility units. A partial scheduling calculation can be performed on the selected subset of process facility units, independently from the rest of the chemical process facility units. A schedule can be calculated for the subset of chemical process facility units, based on the partial scheduling calculation.

### CLAIM OF PRIORITY

This application claims priority on the following application, which is hereby incorporated by reference in its entirety:

U.S. Provisional Application No. 61/390,106, entitled SYSTEM AND METHOD FOR SMART OIL, GAS AND CHEMICAL PROCESS SCHEDULING, filed on Oct. 5, 2010.

### FIELD OF THE INVENTION

This invention relates generally to oil, gas and chemical process scheduling.

### BACKGROUND

Scheduling systems play a vital role in process industry supply chain. The scheduling decisions involve many competing factors such as: achieving economic targets and handling environmental regulations, meeting quality requirements and reducing quality giveaway, supplying adequate feedstock and reducing feedstock inventories, quickly responding to operation disturbances and maintaining operation safety. Scheduling a site is a complex and multi-dimensional task, requiring the coordination of many schedulers and operators.

A scheduling problem can generally be described as a set of objectives and sets of constraints. A scheduling process aims to generate a long-term or a short-term detailed operation plan to achieve these objectives while respecting these constraints. The traditional “black box” optimization approach has not been successful because it is difficult to handle business rule changes and the lack of schedulers' inputs during the scheduling process.

### SUMMARY

A smart process scheduling tool provides a new technology trend for oil, gas and chemical process industry scheduling systems, both in terms of visualization technology and optimization technology. Visualization technology provides the right tool for schedulers to identify the scheduling problems and interactively solve the problems. Optimization technology helps the scheduler achieve maximum profitability and find feasible solutions on short-term and long-term schedules.

Smart scheduling can be supported for an oil, gas and chemical process system with a plurality of process facility units. A user is allowed to first select a subset of process facility units from the plurality of oil, gas and chemical process facility units. Then, a partial scheduling calculation can be performed on the select subset of process facility units, independently from the rest of process facility units in the oil, gas and chemical process system. A schedule can be calculated for the subset of chemical process facility units, based on the partial scheduling calculation.

### BRIEF DESCRIPTION OF THE DRAWINGS

FIG. 1 is an exemplary illustration of an overview of the oil, gas and chemical process scheduling environment.

FIG. 2 is an exemplary illustration of a flow diagram for the oil, gas and chemical process scheduling tool, with the smart simulation feature, in accordance with an embodiment.

FIG. 3 is shows of an exemplary user interface dialog that allows a user to select a flowsheet, in accordance with an embodiment.

FIG. 4 is an exemplary illustration of a crude scheduling flowsheet, in accordance with an embodiment.

FIG. 5 is an exemplary illustration of a gasoline blending flowsheet, in accordance with an embodiment.

### DETAILED DESCRIPTION

The invention is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

Smart scheduling can be supported for an oil, gas and chemical process system with a plurality of process facility units. The oil, gas and chemical process system can include a refinery plant, a petrochemical plant, a liquefied natural gas (LNG) plant or a LNG terminal.

A user is allowed to first select a subset of process facility units from the plurality of oil, gas and chemical process facility units. Then, a partial scheduling calculation, or a smart simulation, can be performed on the select subset of process facility units, independently from the rest of process facility units in the oil, gas and chemical process system. A schedule can be calculated for the selected subset of process facility units, based on the partial scheduling calculation.

The smart simulation feature of the smart process scheduling tool can increase the user interaction speed and shorten the system response time, by letting users focusing on certain facilities within a process model. Furthermore, the smart simulation feature can enable end users to work independently in their own workspace in a multi-user system. Additionally, the smart simulation feature can give users ability to compare different workspaces with respect to simulation speed.

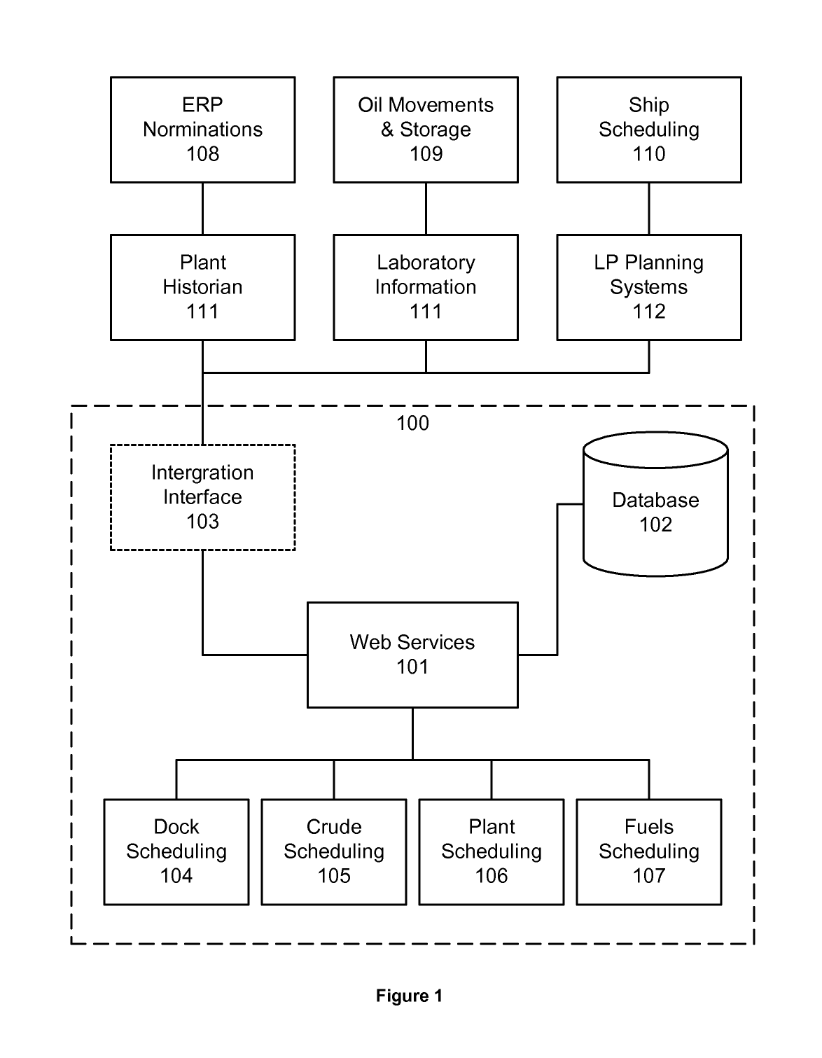

FIG. 1 is an exemplary illustration of an overview of the oil, gas and chemical process scheduling environment.

As shown in FIG. 1, at the center of the oil, gas and chemical process scheduling environment 100 is a web service 101 that connects to a database 102, an integration interface 103, and multiple oil, gas and chemical process scheduling modules, such as a dock scheduling module 104, a crude scheduling module 105, a plant scheduling module 106 and a fuels scheduling module 107. Alternatively, the oil, gas and chemical process scheduling modules can connect to the database, either directly or through another software module.

Also as shown in FIG. 1, the integration interface 103 allows the oil, gas and chemical process scheduling environment 100 to utilize information on ERP nominations 108, oil movements and storage 109, ship scheduling 110, plant historian 111, laboratory information 112, and LP planning systems 113.

Additionally, the oil, gas and chemical process scheduling environment 100 can provide a comprehensive modeling tool as a part of the flexible scheduling platform. The comprehensive modeling tool allows the schedulers to know the finite capacity of a plant to schedule a feasible production. This capacity is generally hidden in the constraints and interdependencies of the plant's facilities. For example, a port can receive or ship certain materials via certain vessels; a tank can service specific products, store a fixed amount, and transfer at a maximum rate; a processing unit has its capacity and yield structure. These facilities are connected by transfer lines and operated by their own rules and sequences. The comprehensive modeling tool can simplify these complexities with graphical representations of production processes.

The comprehensive modeling tool allows a user to model the oil, gas and chemical process facilities via drawing icons and setting their parameters. The comprehensive modeling tool provides flowsheets representing manufacturing or production processes as collections of icons. Each icon represents one or more facilities such as ports, tanks, and processing units connected by transfer lines. Depending on its function, each facility has zero or many parameters to define its identity, capacity, limitations, operating modes, and connections to other facilities. Tank switching sequences can be automated by logic units to control the feed and rundown tanks for unit operations, or the source and destination tanks for receipt and shipment activities. In some examples, tanks can have imperfect mixing. Additionally, each facility can be filled with materials. Materials are tracked by properties and compositions. Materials can belong to pools for common services. Properties can be blended by either a default or user-defined method. In accordance with an embodiment, the model can easily be maintained according to users' feedback.

With the comprehensive modeling tool handling the complexities of the production process, the schedulers can have a flexible scheduling environment and can focus on scheduling using smart simulation. The oil, gas and chemical process scheduling tool, with the smart simulation feature, gives schedulers the flexibility to arrange operational activities to meet short-term deliveries and manage inventory and still observes the plant's finite capacity by enforcing dependencies and constraints.

Additionally, the comprehensive modeling tool can define and use baselines. Each baseline is a set of parametric values of the model at a given time and each baseline represents the status of the plant and its up-to-date capacity. The values in the model include tank inventories, qualities, unit yields, blend compositions, and line fills. From a baseline, schedulers can arrange sequences of operational activities to meet near-term deliveries.

In accordance with an embodiment, a schedule can start from a baseline and roll forward within the scheduling time frame. Gantt charts can be used for graphical representations of a schedule. A schedule includes milestones or events such as a lifting schedule or the start and the end of an operation. A schedule also includes activities between the events. In one embodiment, the activities can be serial or parallel, linked or unlinked. Additionally, activities are represented by bars on the Gantt charts. Schedulers assign activities by creating bars and editing their parameters on a window-based form. Activities can be copied and pasted with or without linking to other activities.

Additionally, schedulers can move and adjust the bars on Gantt charts to manage activities involving receipts, shipments, unit operations, tank-to-tank transfers, pipeline transfers, blends, and facility status changes.

In accordance with an embodiment, Gantt chart filtering allows schedulers to focus on vital activities. Schedulers can receive instant feedbacks about inventories, product qualities, and constraint violations after scheduling changes. Baseline updating functions help schedulers reconcile activities based on actual operations. Schedulers can edit activities to add new information to the schedule and make timely decisions. Schedulers can view links and deviations between schedules and nominations on Gantt charts. Schedulers can use the inventory planning board, a visual tool combining a trend chart and a Gantt chart, to do sensitivity analysis on the effects of new receipts or shipments on inventory and to possibly prevent overflow or underflow conditions. Schedulers can balance between risks and opportunities in preparing a feasible production schedule in a continuous fashion.

The process scheduling tool, with the smart simulation feature, can provide user-friendly interfaces and customizable Gantt charts make schedulers' job easier. While schedulers modify the production schedule in response to opportunities, the scheduling tool provides instant feedback to scheduling changes to reduce the risks of scheduling beyond the plant's capacity.

Furthermore, the oil, gas and chemical process scheduling tool, with the smart simulation feature, can enhance monitoring performance. The smart simulation engine drives the instant feedback to monitor the performance of a schedule. The smart simulation predicts raw materials inventories and qualities, production rates, unit yields, and product quantities and qualities, while enforcing interdependencies and constraints defined by the model.

Additionally, using the smart simulation feature, schedulers can obtain the status of the production process at any time within the scheduling time frame. Schedulers can set the time by entering a value or sliding the arrow on a time bar. In different examples, depending on the size of the model and the time frame, the smart simulation can take a few seconds or minutes to execute.

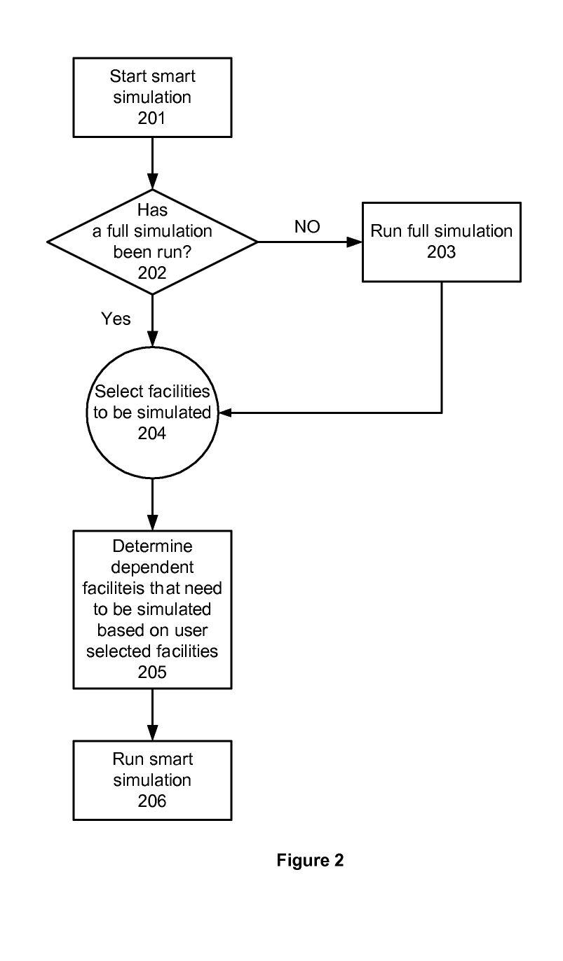

FIG. 2 is an exemplary illustration of a flow diagram for the oil, gas and chemical process scheduling tool, with the smart simulation feature, in accordance with an embodiment.

As shown in FIG. 2, the smart simulation starts, at step 201. The oil, gas and chemical process scheduling tool first check whether a full simulation has been run, at step 202. In the case when a full simulation has not been run, the oil, gas and chemical process scheduling tool can run a full simulation over the underlying oil, gas and chemical process system, at step 203. Otherwise, if a full simulation has been run and the result of the full simulation is available, the oil, gas and chemical process scheduling tool allows a user to select a subset of facility units from the underlying oil, gas and chemical process system, at step 204. Then, the scheduling tool determines one or more dependent facility units that need to be simulated based on the select subset of facility units, at step 205, before the scheduling tool runs the smart simulation, or a partial simulation over the select subset of facility units and all dependent facility units, at step 206. In one embodiment, the selection of the subset of units 204 can also be done before the step 201.

In accordance with an embodiment, the related or dependent facilities can be determined for smart simulation based on flowpipe links among facilities. For example, unit A depends on unit B if unit B has a yield as feeding into unit A. In smart simulation, if unit B is selected but unit A is not selected, then, after a first full simulation of all facility units, unit A assumes that the yield of unit B, such as rate, composition and qualities, has a static profile. In another example, if a unit is fed from an oil tank, then the unit operation depends on the tank. However, the tank is excluded if the tank is not on any of the selected flowsheets. In yet another example, in order to determine correct dependencies among the facility units in an oil, gas and chemical process system, the smart scheduling tool requires the modeler to link the facility units in the correct flowpipe(s) or explicitly define the dependency in a data structure, such as a tree or a list, or other appropriate data structures.

Additionally, the oil, gas and chemical process scheduling tool can provide a user interface dialog for a user to enable or disable the smart simulation feature during application running. In one example, a menu item is implemented under a menu “Simulation”. By checking or un-checking the menu item “Use Smart Simulation”, the smart simulation feature can be activated or disabled. When the smart simulation feature is disabled, a full simulation of the whole process plant model is always performed.

If a user disables the smart simulation feature, the oil, gas and chemical process scheduling tool allows the oil, gas and chemical process scheduling simulation to be done for the whole oil, gas and chemical process system in different settings, such as: One-day at a time, Simulation of the entire schedule duration, or Simulation of the entire schedule duration on the background.

The smart simulation feature can provide the ability to explore what-if analyses to oil, gas and chemical process system personnel, such as plant managers, crude traders, and plant operators, with information to make informed decisions addressing marketing and operating variations.

For example:
a. A refinery manager may ask what plan the refinery should follow to meet its goal when demands for certain products have changed.
b. A crude trader may ask what crude oil should be purchased, how the new crude fits in with the existing crude mix, and whether it is compatible with processing units.
c. A planner may ask whether a product should be shipped from the East Coast to the West Coast or acquired from an external source locally.
d. A refinery scheduler may ask what inventory levels in crude tanks should be maintained to reduce demurrage costs due to unloading delays and to prevent unit shutdown or slowdown due to low feed supply or when certain products should be blended to prevent late shipments.
e. A unit process engineer may ask what the impacts on downstream units are when a unit is taken off-line.
f. A plant operator may ask how close to the operational limits a process unit should run with a type of new feedstock.

The oil, gas and chemical process scheduling tool, with the smart simulation feature, can simulate these scenarios and provide oil, gas and chemical process system personnel with qualitative and quantitative information to make decisions in a time-constrained environment.

The smart simulation feature in the oil, gas and chemical process scheduling tool can provide solutions for different industries. For example, an oil refining industry solutions can support a full range of refinery scheduling activities such as optimizing blends, generating unit operations, arranging crude receipts, handling feed stock run-out, updating baselines, managing unit yields, schedule reporting, and powerful modeling capabilities. Furthermore, a petrochemical industry solution can track inventory, property, and composition across a petrochemical plant. It optimizes unit feeds, calculates unit yields, and manages product lifting. Petrochemical solution provides powerful tools for schedulers to react quickly to unexpected events, handle what-if analysis, and automate whole scheduling processes. A liquefied natural gas (LNG) industry solution can include special features for vaporization and boil-off management. In one example, simulation over years of shipper activities can be done in seconds. A terminal solution can provide an integrated scheduling solution for terminal operations. The terminal solution links shippers and schedulers, and provides powerful tools to schedule and optimize terminal operations.

The oil, gas and chemical process scheduling tool, with the smart simulation feature, can save the refinery money by tracking feedstock inventories. It tells schedulers the exact time window in the near future to bring in a certain feedstock. Tank underflow and demurrage can be significantly reduced. It can also improve inventory management and prevent incidents such as unit shutdown, tank overflow, tank underflow, and late shipment. It can also help the refinery plan for the long term. Refinery traders can decide when to buy and sell certain materials and in what approximate amounts. It gives a refinery the ability to evaluate a new or price-advantaged feedstock available in the market and to determine its compatibility with existing feedstocks and processing units.

Additionally, the oil, gas and chemical process scheduling tool, with the smart simulation feature, can give users the flexibility to simulate the whole plant or just one processing unit. Users can easily change operating parameters through an interface window to evaluate the impact of different operating conditions before applying the selected condition to the real world production. The smart simulation feature provides users with the ability to prepare for and adapt to daily supply changes.

In the smart simulation, a subset of the facilities can be simulated and the rest of the model can use previous simulated data stored in the memory to provide continuous and full model results. Hence, with smart simulation functionality, users are able to see an increase in simulation speed as well as work independently in a multi-user scenario. In addition to that, users are able to compare the simulation speed and results between different workspaces by including different combinations of facilities or flowsheets.

Users can select a subset of facilities from the whole process plant model for simulation in many different ways. One exemplary user interface can contain sections for selecting specific facilities such as, tanks, process units and pipelines. In addition to these, it can be optional for user to select specific flowsheet or flowsheets in the model. In another example, the selection can be defined during the facility configuration. In yet another example, a scheduling tool allows users to select a flowsheet or multiple flowsheets as the subset of the model.

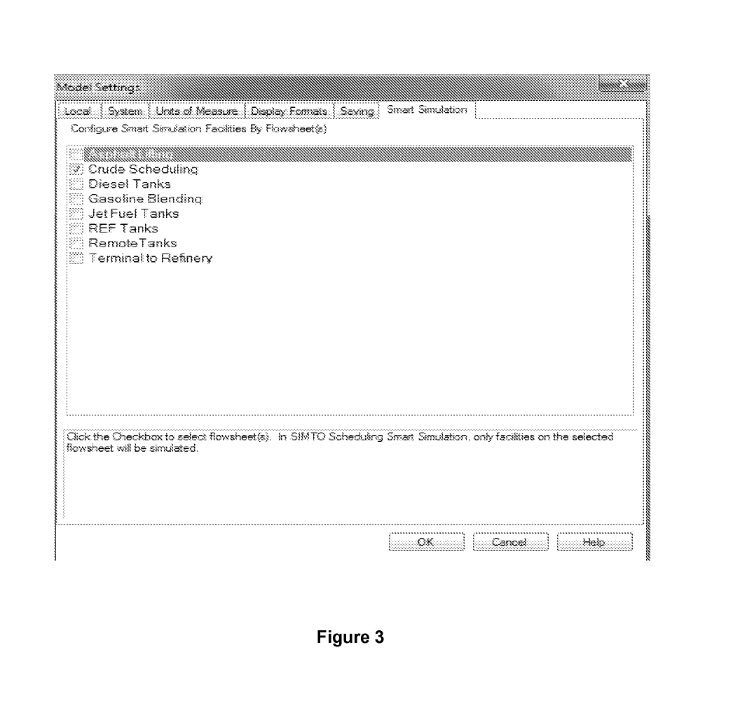

FIG. 3 is shows of an exemplary user interface dialog that allows a user to select a flowsheet, in accordance with an embodiment.

As shown in FIG. 3, different types of flowsheet(s) can be selected from a user interface dialog. There can be a asphalt lifting flowsheet, a crude scheduling flowsheet, a diesel tanks flowsheet, a gasoline blending flowsheet, a jet fuel tanks flowsheet, a REF tanks flowsheet, a remote tanks flowsheet, and a terminal to refinery flowsheet.

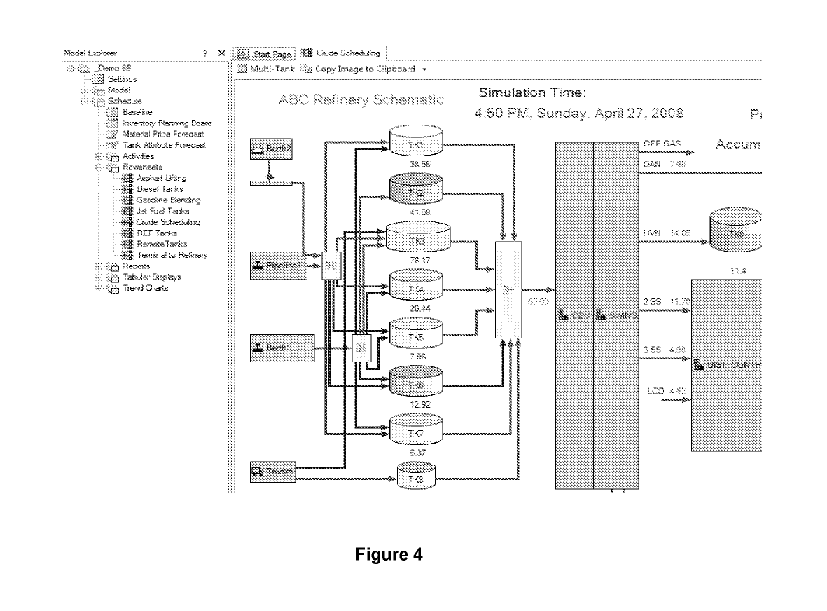

FIG. 4 is an exemplary illustration of a crude scheduling flowsheet, in accordance with an embodiment.

As shown in FIG. 4, crude tanks are scheduled to feed the crude units. Meanwhile, crudes are also scheduled to be unloaded from a berth into one or several crude tanks. Scheduled crude yields, such as kerosene, diesel, and gas oil, are fed into downstream units or stored in intermediate tanks. The flowpipe lines illustrate material flow through. The lines illustrate idle status of the flowpipes.

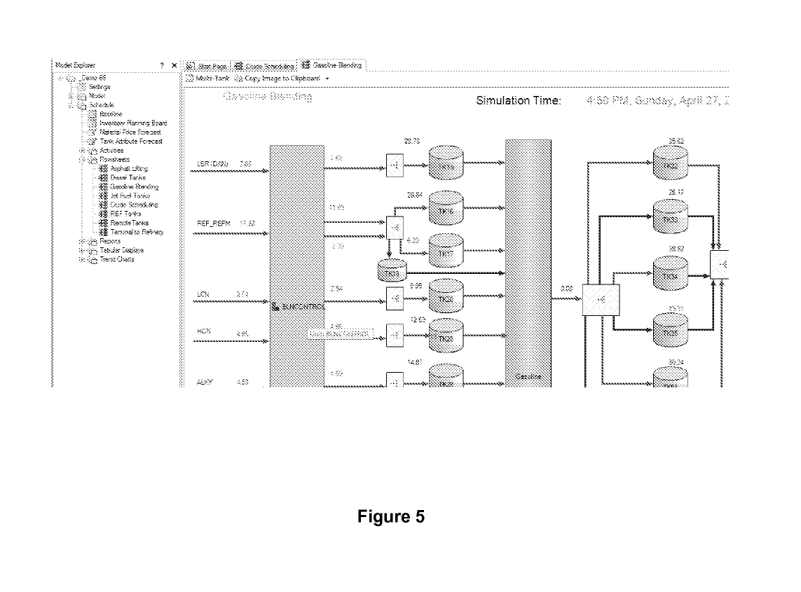

FIG. 5 is an exemplary illustration of a gasoline blending flowsheet, in accordance with an embodiment.

As shown in FIG. 5, gasoline blending component tanks are modeled on the left side of the blender unit. Gasoline product tanks are modeled on the right side of the blender units. Components from component tanks are scheduled to be blended into different grade of gasoline. Gasoline products are scheduled to run down to product tanks for shipment.

In accordance with an embodiment, when a model is designed for multiple users, and used by multiple users, simulation speed for a full simulation can slow down since it need to take into account the schedules made by every user and managed in the same plant model. Smart simulation can address this issue by letting each user of the same model select a subset of facilities within the same model to be included when simulation is performed.

In accordance with an embodiment, a data business management layer, for example using web service, can be used to support the oil process scheduling in an environment with multiple users. The web service provides information on both the data model for the plurality of oil, gas and chemical process facility units and settings for each of the plurality of users. A plurality of scheduling terminals can be connected to the web server through internet. Each terminal allows a user to select a subset of oil, gas and chemical process facility units from the plurality of chemical process facility units, and performs a separate partial scheduling calculation on the select subset of oil, gas and chemical process facility units independently from the rest of the chemical process facility units.

For example, in a given refinery, there are three schedulers in the planning and economics department to schedule the whole plant. All schedulers are using the same data model but schedule different area of the refinery. This can include: Crude receipt and crude feeding, Intermediate unit operation, Product blending and lifting (shipment).

Without smart simulation, whenever a scheduler run the simulation, the scheduling software will run the full refinery simulation. While the crude scheduler tries to assign a crude ship that is coming six days later to a berth, the crude scheduler unloads the crude to one or several tanks. To make the right selection, the crude scheduler needs to heck the tank inventory level and compatibility of the existing crude type in tank(s) against the crude on the ship. The crude scheduler runs a full simulation of the refinery model to find out the information six days from the present time. Generally, the intermediate unit operation or the product scheduling won't affect the crude scheduler's decision making. So, the simulation runs too many other tasks to reach the six days end point. The unnecessary simulation and delay of response always distract user from their decision making.

With Smart Simulation in the scheduling tool, the crude scheduler can select the units or facilities as a subset. Smart simulation keeps the setting for the user and runs simulation and update on those units and facilities only. Quick simulation results feedback that not only saves the time for user but also allocates the valuable time for user to make more economical decisions for the plants.

In the same example, the product scheduler can benefit from the smart simulation also. While the product scheduler is scheduling like plant to blend a few batch of gasoline from different blend stocks, the blend component units generally are running at full capacity and relatively stable yield qualities. So, the crude scheduler's schedule normally has no impact on the blending and lifting schedule.

In the above example, if the computer power is similar among the schedulers' machines and the simulation takes roughly equal time to finish each scheduler's task, with Smart Simulation, each of schedulers can save 60% of the simulation time on their daily jobs.

The foregoing description of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

One embodiment of the present invention is a computer-implemented method to support performance monitoring of distributed transaction service that comprises receiving monitoring data from one or more distributive transaction monitoring processes by one or more local monitoring servers; accepting monitoring data from one or more local monitoring servers by a central monitor server and storing monitoring data into a database; and communicating with the central monitor server using a web application and providing interaction with a user.

One embodiment includes a computer program product which is a storage medium (media) having instructions stored thereon/in which can be used to program a computer to perform any of the features present herein. The storage medium can include, but is not limited to, any type of disk including floppy disks, optical discs, DVD, CD-ROMs, micro drive, and magneto-optical disks, ROMs, RAMs, EPROMs, EEPROMs, DRAMs, flash memory of media or device suitable for storing instructions and/or data stored on any one of the computer readable medium (media), the present invention can include software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and user applications.

Embodiments of the present invention can include providing code for implementing processes of the present invention. The providing can include providing code to a user in any manner. For example, the providing can include transmitting digital signals containing the code to a user; providing the code on a physical media to a user; or any other method of making the code available.

Embodiments of the present invention can include a computer implemented method for transmitting code which can be executed at a computer to perform any of the processes of embodiments of the present invention. The transmitting can include transfer through any portion of a network, such as the Internet; through wires, the atmosphere or space; or any other type of transmission. The transmitting can include initiating a transmission of code; or causing the code to pass into any region or country from another region or country. For example, transmitting includes causing the transfer of code through a portion of a network as a result of previously addressing and sending data including the code to a user. A transmission to a user can include any transmission received by the user in any region or country, regardless of the location from which the transmission is sent.

Embodiments of the present invention can include a signal containing code which can be executed at a computer to perform any of the processes of embodiments of the present invention. The signal can be transmitted through a network, such as the Internet; through wires, the atmosphere or space; or any other type of transmission. The entire signal need not be in transit at the same time. The signal can extend in time over the period of its transfer. The signal is not to be considered as a snapshot of what is currently in transit.

The forgoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. For example, steps preformed in the embodiments of the invention disclosed can be performed in alternate orders, certain steps can be omitted, and additional steps can be added. The embodiments where chosen and described in order to best explain the principles of the invention and its practical application, thereby enabling others skilled in the art to understand the invention for various embodiments and with various modifications that are suited to the particular used contemplated. It is intended that the scope of the invention be defined by the claims and their equivalents.

What is claimed is:

1. A method to support oil, gas and chemical process scheduling, comprising:
allowing a user to select a subset of oil, gas and chemical process facility units from a plurality of oil, gas and chemical process facility units;
performing a partial scheduling calculation on the selected subset of oil, gas and chemical process facility units independently from the rest of the oil, gas and chemical process facility units.

2. The method according to claim 1, further comprising:
allowing each said oil, gas and chemical process facility unit to perform at least one job functionality of:
crude receipt and crude feeding,
intermediate unit operation, and
product blending and lifting.

3. The method according to claim 1, further comprising:
allowing the partial scheduling calculation to be one of:
a dock scheduling calculation,
a crude scheduling calculation,
a plant scheduling calculation, and
a fuels scheduling calculation

4. The method according to claim 1, further comprising:
performing a full scheduling calculation on the plurality of oil, gas and chemical process facility units.

5. The method according to claim 4, further comprising:
basing the partial scheduling calculation on the select subset of facility units on a result set from a full scheduling calculation on the plurality of oil, gas and chemical process facility units.

6. The method according to claim 1, further comprising:
keeping a group of setting for the user.

7. The method according to claim 1, further comprising:
connecting to a web server that maintains information on the plurality of oil, gas and chemical process facility units and a plurality of users.

8. The method according to claim 1, further comprising:
allowing another user to select another subset of oil, gas and chemical process facility units from a plurality of oil, gas and chemical process facility units;
performing, in parallel, another partial scheduling calculation on the another selected subset of facility units independently from the rest of the oil, gas and chemical process facility units.

9. The method according to claim 8, further comprising:
allowing the partial scheduling calculation to be a crude scheduling calculation; and
allowing the another partial scheduling calculation to be a product blending and lifting scheduling calculation.

10. The method according to claim 1, further comprising:
using a flowsheet that represents manufacturing or production process as a collection of icons.

11. The method according to claim 1, further comprising:
maintaining a data model based on feedback from one or more users.

12. The method according to claim 1, further comprising:
providing instant feedback to the user with information on inventories, product qualities, and constraint violations after scheduling change.

13. The method according to claim 1, further comprising:
using a chart filtering that allows the user to focus on one or more vital activities on the selected subset of chemical process facility units

14. A machine readable medium having instructions stored thereon that when executed cause a system to:
allow a user to select a subset of oil, gas and chemical process facility units from a plurality of oil, gas and chemical process facility units;
perform a partial scheduling calculation on the selected subset of oil, gas and chemical process facility units independently from the rest of the oil, gas and chemical process facility units.

15. A method to support oil, gas and chemical process scheduling, comprising:
a business data layer like web server that maintains information on a plurality of oil, gas and chemical process facility units and a plurality of users; and
a plurality of scheduling terminals, wherein each said terminal
allows a user to select a subset of oil, gas and chemical process facility units from the plurality of chemical process facility units, and
performs a partial scheduling calculation on the selected subset of chemical process facility units independently from the rest of the oil, gas and chemical process facility units.
